(19) United States
(12) Patent Application Publication
(10) Pub. No.: US 2026/0261711 A1
(43) Pub. Date: Sep. 3, 2026

(54) PROGRESSIVE RECONSTRUCTION OF A REFERENCE FRAME IN VIDEO CODING

(71) Applicant: Fraunhofer-Gesellschaft zur Förderung der angewandten Forschung e.V., München (DE)

(72) Inventors: Shahid Mahmood SATTI, Erlangen (DE); Srivatsa Venkatachari PRATIVADIBHAYANKARAM, Erlangen (DE); Simone NEUKAM, Erlangen (DE); Thomas RICHTER, Erlangen (DE); Felix FLECKENSTEIN, Erlangen (DE); Kanav BHARDWAJ, Erlangen (DE); Herbert THOMA, Erlangen (DE); Siegfried FÖßEL, Erlangen (DE); Frederik NAGEL, Erlangen (DE)

(21) Appl. No.: 19/066,592

(22) Filed: Feb. 28, 2025

(51) Int. Cl. H04N 19/64; H04N 19/137; H04N 19/88

(52) U.S. Cl. CPC H04N 19/64; H04N 19/137; H04N 19/88

(57) ABSTRACT

In embodiments of the disclosed invention, a progressive reconstruction scheme for an independently decodable picture of a video, a restoration model is used for deriving a restored representation of a picture, which is used as a basis for reconstructing a subsequent picture using a motion description. In further embodiments, an encoder for encoding a sequence of pictures transforms a picture. The encoder determines a distribution of channels of the transformed representation of the picture to groups and encodes the groups into a data stream by interleaving the groups with motion descriptions of further pictures relative to the first picture.

Embodiments of the present invention relate to an apparatus or a method for decoding or reconstructing a video from a data stream. Further embodiments of the invention relate to an apparatus or a method for encoding a video into a data stream. For example, embodiments may relate to progressive I-frame refresh in learned video coding.

For example, embodiments of the invention may relate to the field of low bitrate neural-network-based video coding, for example, a video messaging or conferencing applications, where the input is usually a face video (typical in conversational applications such as video conferencing) or can be any general video.

### BACKGROUND OF THE INVENTION

In applications imposing a requirement of low bitrate, the source video is usually of low spatial resolution (standard definition or lower). An approach for encoding, transmitting and reconstructing a video in low-bitrate applications is described the following with respect to FIG. 1 and FIG. 2, which show a high-level workflow of an example of a parametric-based low bitrate video codec. The first frame (intra-frame or I-frame) in a group of pictures (GOP) is encoded using a classical or a neural-network-based image codec. For all other frames in the GOP, e.g., referred to as predicted frames or P-frames, only the motion information between the frame and previous I-frame is encoded using parametric video coding e.g., (including but not limited to) landmark points or key-points. At the decoder side, I-frame is decoded using a corresponding image decoder, while other frames in the GOP are animated using the I-frame and the parametric dense motion prediction based on landmark/key-points. Since the animation quality highly depends on the reconstructed quality of the first image, the I-frame is encoded at a high bitrate. This leads to high bitrate overshoots for I-frame compared to the parametrically coded frames.

In learning-based image coding, an image x is transformed into a latent representation y using an analysis transform, which is composed of deep neural networks. The latent representation y is quantized and entropy coded into a bitstream. The quantized latent is recovered at the decoder, after which the image \hat{x} is reconstructed by another neural network called the synthesis transform. The workflow of a learning-based image compression framework is shown in FIG. 3. The latent representation usually has the dimensions C×h×w, where C is the number of channels, h represents the height and w the width of the latent frame. Each latent channel captures a specific feature of the image to be compressed.

In learned video coding for low bitrate, low delay applications [1], the bitrate ratio between I-frame to non-I-frame size is much larger than in conventional video coding. This is because, in parametric video coding, frames are represented with lightweight motion information, and the source frame (i.e., I-frame) needs to be encoded at a fairly high quality to facilitate the image animation. In low-bitrate video coding, while the average bitrate needs to be kept as low as possible, at the same time, the bitrate needs to remain approximately constant to avoid the necessity of a large buffer and the introduction of transmission delays. Note that in conversational applications, a non-timely reception of frames at the decoder due to network delays will lead to freezes, consequently dropping the video call quality.

The problem of I-frame related delay is well known in classical block-based video coding [2], [3]. While I-frames are bitrate expensive to encode, they are also needed to allow random access and error resilience in the video bitstream. In classical video coding, decorrelation transforms are used to decompose the signal into frequency bands. More loss is tolerated in those frequencies to which the human visual system is less sensitive. Compression efficiency is achieved by dropping frequency information which cannot be perceived by human. In learning-based image coding (FIG. 3), the latent space consists of matrices of multiple channels, each of which contributes to a certain amount of detail in the picture. Unlike decorrelation transforms, which can order the signal in terms of frequency, no natural channel ordering exists in latent space of a neural-network-based image codec. However, the channels in the latent space can be rearranged in such a way that channels containing more important information are transmitted before the channels carry less important information. An example of such a reordering is evaluated in [6].

It is noted that the details described above may optionally be implemented in any of the embodiments of the invention.

It would be desirable to provide a video coding concept, which provides an improved trade-off between a low average bitrate, a low variation of the bitrate, and a high quality of the reconstructed video, e.g., in terms of a low distortion of the reconstructed video with respect to the original video and/or a low degree of perceptible image errors.

### SUMMARY

An embodiment may have an apparatus for decoding a sequence of pictures from a data stream, configured for decoding, from the data stream, a first group of channels of a transformed representation of a first picture of the sequence of pictures, wherein the transformed representation includes a plurality of channels, the plurality of channels being distributed to a plurality of groups including the first group and a second group, obtaining a reconstructed representation of the first picture by subjecting the first group of channels to a transform, the transform being non-linear, subjecting the reconstructed representation to a restoration model to obtain a restored representation of the first picture, decoding, from the data stream, a motion description of a second picture, which follows the first picture in the sequence of pictures, and reconstructing the second picture based on the restored representation of the first picture and the motion description of the second picture.

Another embodiment may have an apparatus for encoding a sequence of pictures into a data stream, configured for transforming a first picture of the sequence of pictures using a non-linear transform to obtain a transformed representation of the first picture, the transformed representation including a plurality of channels, distributing the channels to a plurality of groups in dependence on the plurality of channels, wherein the plurality of groups includes a first group and one or more second groups, inserting the first group into the data stream, deriving, based on the first picture, for each of a plurality of second pictures of the sequence of pictures, which follow the first picture in the sequence of pictures, a motion description, and encoding the motion descriptions of the second pictures and the second groups into the data stream by interleaving the motion descriptions of the second pictures with the one or more second groups.

Another embodiment may have an apparatus for decoding a sequence of pictures from a data stream, configured for decoding, from the data stream, a first group of channels of a transformed representation of a first picture of the sequence of pictures, wherein the transformed representation includes a plurality of channels, the plurality of channels being distributed to a plurality of groups including the first group and a second group, obtaining a reconstructed representation of the first picture by subjecting the first group of channels to a non-linear transform, decoding, from the data stream, a motion description of a second picture, which follows the first picture in the sequence of pictures, and reconstructing the second picture based on the reconstructed representation of the first picture and the motion description of the second picture, wherein each of the plurality of channels of the transformed representation is associated with one of a plurality of input channels of the non-linear transform, and wherein the apparatus is configured for deriving, from the data stream, an indication of the input channels with which the channels of the first group are associated.

According to another embodiment, a method for decoding a sequence of pictures from a data stream may have the steps of: decoding, from the data stream, a first group of channels of a transformed representation of a first picture of the sequence of pictures, wherein the transformed representation includes a plurality of channels, the plurality of channels being distributed to a plurality of groups including the first group and a second group, obtaining a reconstructed representation of the first picture by subjecting the first group of channels to a transform, the transform being non-linear, subjecting the reconstructed representation to a restoration model to obtain a restored representation of the first picture, decoding, from the data stream, a motion description of a second picture, which follows the first picture in the sequence of pictures, and reconstructing the second picture based on the restored representation of the first picture and the motion description of the second picture.

According to another embodiment, a method for encoding a sequence of pictures into a data stream may have the steps of: transforming a first picture of the sequence of pictures using a non-linear transform to obtain a transformed representation of the first picture, the transformed representation including a plurality of channels; distributing the channels to a plurality of groups in dependence on the plurality of channels, wherein the plurality of groups includes a first group and one or more second groups; inserting the first group into the data stream; deriving, based on the first picture, for each of a plurality of second pictures of the sequence of pictures, which follow the first picture in the sequence of pictures, a motion description; and encoding the motion descriptions of the second pictures and the second groups into the data stream by interleaving the motion descriptions of the second pictures with the one or more second groups.

According to another embodiment, a method for decoding a sequence of pictures from a data stream may have the steps of: decoding, from the data stream, a first group of channels of a transformed representation of a first picture of the sequence of pictures, wherein the transformed representation includes a plurality of channels, the plurality of channels being distributed to a plurality of groups including the first group and a second group, obtaining a reconstructed representation of the first picture by subjecting the first group of channels to a transform, the transform being non-linear, decoding, from the data stream, a motion description of a second picture, which follows the first picture in the sequence of pictures, and reconstructing the second picture based on the reconstructed representation of the first picture and the motion description of the second picture, wherein each of the plurality of channels of the transformed representation is associated with one of a plurality of input channels of the non-linear transform, and wherein the method includes deriving, from the data stream, an indication of the input channels with which the channels of the first group are associated.

Another embodiment may have a non-transitory digital storage medium having stored there on a data stream, the data stream signaling a sequence of pictures, wherein the sequence of pictures is encoded into the data stream using the method for decoding a sequence of pictures from a data stream having the steps of: decoding, from the data stream, a first group of channels of a transformed representation of a first picture of the sequence of pictures, wherein the transformed representation includes a plurality of channels, the plurality of channels being distributed to a plurality of groups including the first group and a second group, obtaining a reconstructed representation of the first picture by subjecting the first group of channels to a transform, the transform being non-linear, subjecting the reconstructed representation to a restoration model to obtain a restored representation of the first picture, decoding, from the data stream, a motion description of a second picture, which follows the first picture in the sequence of pictures, and reconstructing the second picture based on the restored representation of the first picture and the motion description of the second picture.

Another embodiment may have a non-transitory digital storage medium having stored there on a computer program for implementing any of the inventive methods when being executed on a computer or signal processor.

Embodiments of the invention rely on the idea to employ, in a progressive reconstruction scheme for an independently decodable picture (e.g., referred to as I-frame) of a video, according to which scheme an independently decodable picture is transmitted portion-wise, a restoration model, e.g., a machine learning model trained for restoring a lossy, or distorted, picture. The restored decoded picture may then be used on decoder side for reconstructing a dependently coded picture. For example, an independently coded picture is a picture that is encoded into the data stream without using other pictures of the video, e.g., without prediction from other pictures. This independently coded picture, also referred to as I-frame, is transmitted portion-wise. The portions may be interleaved with further pictures of the video, e.g., dependently coded pictures, which are encoded into the data stream using the independently coded picture as reference. Thus, until having received all portions of the independently coded picture, the decoder has only incomplete information for reconstructing the independently coded picture, so that reconstructing the picture will lead to a lossy or distorted representation of the independently coded picture, having a lower quality as the original picture. This circumstance does not only have the effect that the independently coded picture, when presented, may be distorted, but, as the independently coded picture is used as reference for decoding subsequent dependent pictures, the distortion also affects the reconstruction of these dependent pictures. Subjecting the reconstruction of the independently coded picture to a restoration model may improve the quality of the reconstructed picture, e.g., reduce artifacts or distortions, thereby not only improving the quality of the output picture of the independently coded frame, but also improving the quality of dependently coded pictures, which are reconstructed based on the independently coded picture.

In other words, while progressive transmission of independently coded pictures may provide for a more constant bitrate compared to transmitting the independently coded picture as a whole, e.g., at the beginning of a sequence of pictures, it may reduce the quality of the reconstruction of pictures before the entire independently coded picture is received. The usage of the restoration model may reduce this loss of quality. Furthermore, the size to which the independently coded picture substantially influences the average bitrate on the one hand, and the quality of all frames including the dependent ones on the other hand. The usage of the restoration model may allow for a high quality of the reconstructed video at a comparably low bitrate spent for the independently coded picture. Thus, the usage of the restoration model allows an improved tradeoff between a more constant bitrate, a low average bitrate, and a high quality of the reconstructed video.

For example, in general, the low delay nature of conversational applications demands a constant network bitrate with very minimal or no decoder side buffering. Embodiments of this invention provide a way to reduce the bitrate peaks for I-frames by using an image-restoration model, e.g., an image restoration network, to improve the reconstructed quality of I-frame even if it was encoded at a low bitrate. As a result of improving the reconstruction quality of the I-frame, the quality of all animated frames in the GOP also improves. Thus, embodiments provide for both bitrate reduction as well as improving the quality of reconstructed sequence at the decoder.

Embodiments of the invention provide an apparatus for decoding a sequence of pictures from a data stream. The apparatus is configured for decoding, from the data stream, a first group of channels of a transformed representation of a first picture (e.g., an independently coded picture) of the sequence of pictures (e.g., the first picture of the sequence, i.e., an initial picture of the sequence transmitted and to be presented first). The transformed representation comprises a plurality of channels (e.g., each of the channels comprising, or consisting of, an array of transform coefficients), the plurality of channels being distributed to a plurality of groups comprising the first group and a second group. The apparatus is configured for obtaining a reconstructed representation of the first picture by subjecting the first group of channels to a transform (e.g., without using the second group, e.g., only the first group), the transform being non-linear. The apparatus is further configured for subjecting the reconstructed representation to a restoration model (e.g., a machine learning model, e.g., comprising a neural network) to obtain a restored representation of the first picture. The apparatus is configured for decoding (e.g. prior to decoding the second group), from the data stream, a motion description of a second picture, which follows the first picture in the sequence of pictures, and reconstructing the second picture based on the restored representation of the first picture and the motion description of the second picture.

A further embodiment provides a method for decoding a sequence of pictures from a data stream, the method comprising: decoding, from the data stream, a first group of channels of a transformed representation of a first picture of the sequence of pictures, wherein the transformed representation comprises a plurality of channels, the plurality of channels being distributed to a plurality of groups comprising the first group and a second group; obtaining a reconstructed representation of the first picture by subjecting the first group of channels to a transform, the transform being non-linear; subjecting the reconstructed representation to a restoration model to obtain a restored representation of the first picture; decoding, from the data stream, a motion description of a second picture, which follows the first picture in the sequence of pictures, and reconstructing the second picture based on the restored representation of the first picture and the motion description of the second picture.

Further embodiments of the invention rely on the idea to encode a picture into a data stream in units of channel groups, each of which comprises one or more channels of a transformed representation of the picture obtained by a non-linear transform, the channel groups being encoded into the data stream to be interleaved with one or more further pictures of the video. In particular, embodiments of the invention rely on the idea to determine a distribution of the channels of the transformed representation to the channel groups in dependence on the plurality of channels. In other words, the plurality of channels of the transform representation may be evaluated in order to determine the distribution to the channel groups. Determining the distribution in dependence on the plurality of channels resulting from the transform of the picture, allows distributing the channels in a manner that that a low variance of the bitrate is achieved and/or in a manner that channels carrying more relevant information, e.g., information that has greater effect on the reconstruction quality, is signaled in an earlier group compared to less relevant information, which has less effect on the reconstruction quality. Thus, the determination of the distribution may provide for an improved trade-off between a more constant bitrate and a high reconstruction quality, in particular of early frames of the video.

For example, for a given bitrate, one can make sure that most important information of the I-frame is encoded in the bitstream by sending the channels which are most relevant to improve the quality of the reconstructed I-frame at the decoder. For example, embodiments of the invention provide a methodology to split the latent space of a learned image codec in terms of optimizing the quality of image reconstruction with respect to the bitrate.

Embodiments of the invention provide an apparatus for encoding a sequence of pictures into a data stream. The apparatus is configured for transforming a first picture (e.g., an independently coded picture) of the sequence of pictures (e.g., the first picture of the sequence, i.e., an initial picture of the sequence transmitted and to be presented first) using a non-linear transform (e.g., using an analysis transform, e.g., provided by one or more neural networks, e.g., DNNs) to obtain a transformed representation (e.g., a feature representation or latent representation) of the first picture. The transformed representation comprises a plurality of channels (e.g., each of the channels comprising, or consisting of, an array of transform coefficients). The apparatus is configured for distributing the channels to a plurality of groups in dependence on the plurality of channels, e.g., configured for determining a distribution of the channels to the groups, e.g., by evaluating the channels, e.g., values of coefficients or features of the channels. The plurality of groups comprises (or consists of) a first group and one or more second groups. The apparatus is configured for inserting (e.g., encoding) the first group into the data stream. Furthermore, the apparatus is configured for deriving, based on the first picture, for each of a plurality of second pictures of the sequence of pictures, which follow the first picture in the sequence of pictures (e.g., dependently coded pictures), a motion description. For example, the motion description for a second picture describes a motion, or a motion field, between the first picture and the second picture, or between one of the pictures (e.g., the first or one of the second pictures) preceding the subsequent pictures in the sequence of pictures and the second picture. The apparatus is configured for encoding (e.g., sequentially encoding) the motion descriptions of the second pictures and the second groups into the data stream by interleaving the motion descriptions of the second pictures with the second groups. For example, the motion descriptions and the second pictures may be encoded into the data stream by alternatingly encoding one of the motion descriptions of the second pictures and one of the second groups.

In other words, the apparatus may determine the distribution of channels onto groups by taking into account the specific transformed representation of the first picture, so that the distribution may be specific to the first picture. This individualized determination of the distribution allows for a precise adaption of the distribution of channels to the properties of the pictures, and may thus provide for an improved tradeoff between a low variance of the bitrate and a high reconstruction quality.

A further embodiment provides an apparatus for decoding a sequence of pictures from a data stream. The apparatus is configured for: decoding, from the data stream, a first group of channels of a transformed representation of a first picture of the sequence of pictures, wherein the transformed representation comprises a plurality of channels, the plurality of channels being distributed to a plurality of groups comprising the first group and a second group; obtaining a reconstructed representation of the first picture by subjecting the first group of channels to a non-linear transform; decoding, from the data stream, a motion description of a second picture, which follows the first picture in the sequence of pictures; reconstructing the second picture based on the reconstructed representation of the first picture and the motion description of the second picture. Each of the plurality of channels of the transformed representation is associated with one of a plurality of input channels of the non-linear transform. The apparatus is configured for deriving, from the data stream, an indication of the input channels with which the channels of the first group are associated.

A further embodiment provides a method for encoding a sequence of pictures into a data stream, the method comprising: transforming a first picture of the sequence of pictures to obtain a transformed representation of the first picture, the transformed representation comprising a plurality of channels; distributing the channels to a plurality of groups, wherein the plurality of groups comprises a first group and one or more second groups; inserting the first group into the data stream; deriving, based on the first picture, for each of a plurality of second pictures of the sequence of pictures, which follow the first picture in the sequence of pictures, a motion description; and encoding the motion descriptions of the second pictures and the second groups into the data stream by interleaving the motion descriptions of the second pictures with the second groups.

A further embodiment provides a method for decoding a sequence of pictures from a data stream, the method comprising: decoding, from the data stream, a first group of channels of a transformed representation of a first picture of the sequence of pictures, wherein the transformed representation comprises a plurality of channels, the plurality of channels being distributed to a plurality of groups comprising the first group and a second group; obtaining a reconstructed representation of the first picture by subjecting the first group of channels to a transform, the transform being non-linear; decoding, from the data stream, a motion description of a second picture, which follows the first picture in the sequence of pictures; and reconstructing the second picture based on the reconstructed representation of the first picture and the motion description of the second picture. Each of the plurality of channels of the transformed representation is associated with one of a plurality of input channels of the non-linear transform. The method further comprises deriving, from the data stream, an indication of the input channels with which the channels of the first group are associated.

### BRIEF DESCRIPTION OF THE DRAWINGS

Embodiments of the present invention will be detailed subsequently referring to the appended drawings, in which:

FIG. 1 shows a block diagram for a framework of a video codec according to an embodiment;

FIG. 2 shows a sequence diagram of how I and P frames are encoded/transmitted to the decoder in a conventional video codec;

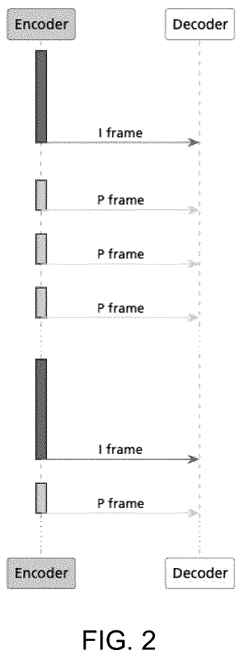

FIG. 3 illustrates an example of a learning-based image compression framework;

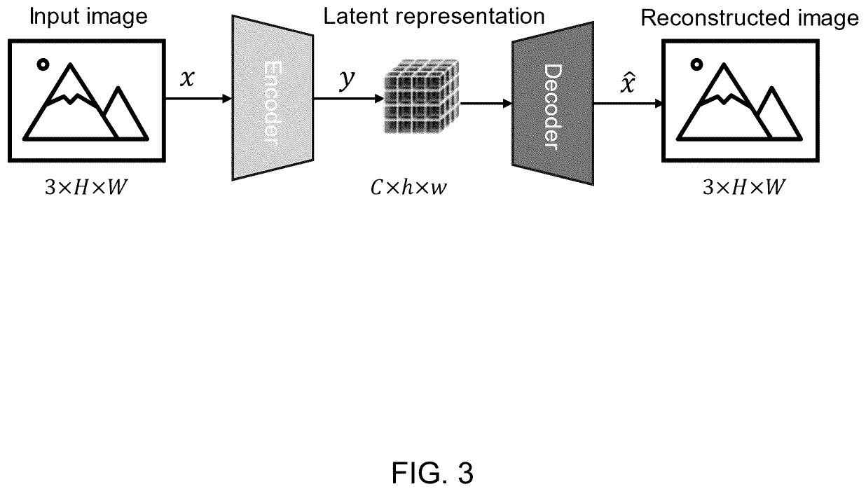

FIG. 4 illustrates a decoder according to an embodiment;

FIG. 5 illustrates the reconstruction of a second picture according to an embodiment;

FIG. 6 illustrates a sequence diagram for progressive I-frame refresh with image-restoration block according to an embodiment;

FIG. 7 illustrates a reconstruction of frames using progressive I-frame refresh with image-restoration block according to an embodiment;

FIG. 8 illustrates a coding scheme for coding the first picture according to an embodiment;

FIG. 9 illustrates an encoder according to an embodiment;

FIG. 10 illustrates a grouping of channels according to an embodiment,

FIG. 11 illustrates a sequence diagram for progressive I-frame refresh according to an embodiment; and

FIG. 12 illustrates a decoder according to another embodiment.

### DETAILED DESCRIPTION OF THE INVENTION

Embodiments of the present invention are now described in more detail with reference to the accompanying drawings, in which the same or similar elements or elements that have the same or similar functionality have the same reference signs assigned or are identified with the same name. In the following description, a plurality of details is set forth to provide a thorough explanation of embodiments of the disclosure. However, it will be apparent to one skilled in the art that other embodiments may be implemented without these specific details. In addition, features of the different embodiments described herein may be combined with each other, unless specifically noted otherwise.

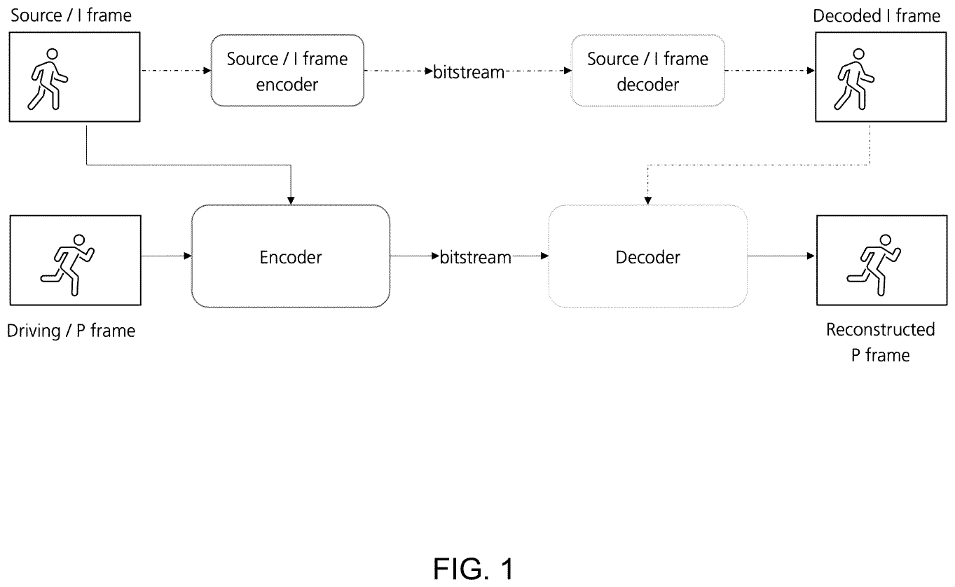

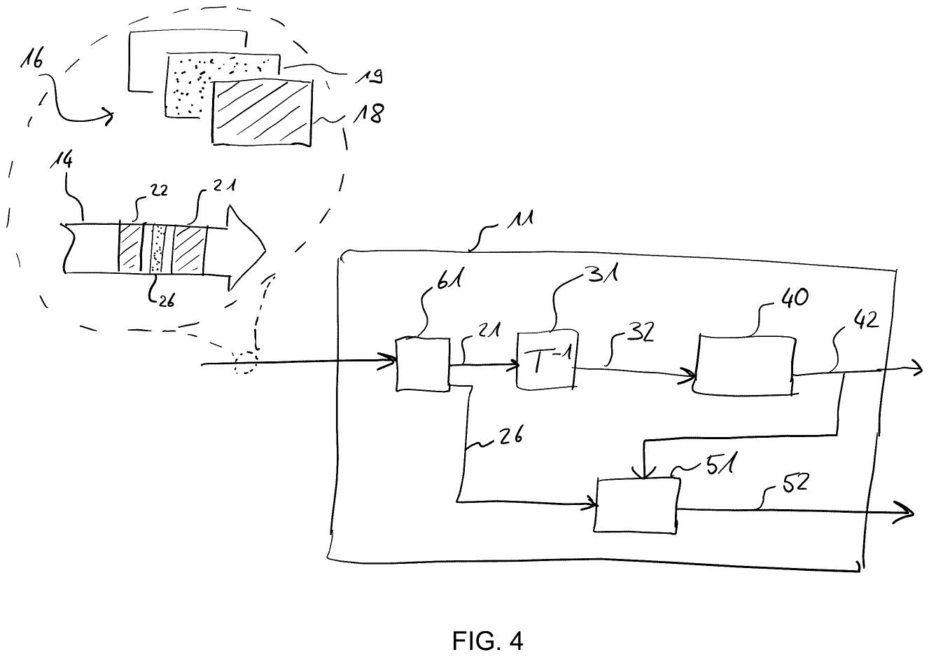

FIG. 4 illustrates an apparatus 11 for reconstructing a sequence 16 of pictures from a data stream 14. Apparatus 11 may be referred to as decoder 11. For example, the sequence 16 may be referred to as group of pictures, GOP. Data stream 14 has encoded thereinto a transformed representation of a first picture 18 of the sequence 16. For example, the first picture is an independently coded picture of the sequence 16. The first picture 18 may be a firstly transmitted picture of sequence 16, that is, e.g., the first transmitted encoded video data in data stream 14 may relate to the first picture. The transformed representation comprises a plurality of channels, distributed onto to a plurality of groups, also referred to as channel groups. The plurality of groups comprises a first group 21 and at least one second group 22. For example, the plurality of groups consists of the first group and one or more second groups. For example, each of the groups is signaled in an individual section of data stream 14, which sections are interspersed with, or interleaved by, further sections of the data stream, which, e.g., carry information for further pictures of the sequence. For example, as illustrated in FIG. 1, a signaling of a second picture 19 of the sequence 16 is signaled in data stream 14 between the first group 21 and the second group 22.

Apparatus 11 comprises a decoding unit 61 configured for decoding, from the data stream 14, the first group 21 of channels. The first group 21 is input to a transform 31 to obtain a reconstructed representation 32 of the first picture, e.g., referred to as first reconstructed representation. Apparatus 11 subjects the reconstructed representation 32 to a restoration model 40 to obtain a restored representation 42 of the first picture. For example, the restored representation 42 may be output as first frame of a reconstructed sequence of pictures.

In other words, the first frame of the reconstructed sequence of picture may be the restored representation 42 obtained from the first group, e.g., only the first group, e.g., without information of the second group 22 or any further second group.

Decoding unit 61 is further configured for decoding, from the data stream, a motion description 26 of a second picture 19, which follows the first picture 18 in the sequence 16. Apparatus 11 further comprises a motion decoder 51 configured for reconstructing the second picture based on the restored representation 42 of the first picture and the motion description 26 of the second picture to obtain a reconstructed second picture 52.

For example, the motion description 26 indicates a motion within the second picture relative to the first picture, e.g., in form of a motion field, and the motion decoder may derive the reconstructed second picture by applying the motion description 26 to the first picture. For example, the motion description 26 may indicate a motion of key point areas defined within the first picture 18.

For example, the motion description 26 may comprise a set of parameters using which the first picture is deformed to produce the reconstructed second picture.

In other words, for example, the motion description 26 may be determined using a parametric dense motion prediction based on landmark/key-points.

For example, the motion decoder 51 may directly derive the reconstructed second picture by applying the motion description 26 to the first picture, e.g., without using a residual signal, e.g. a residual representing a difference between the second picture and a prediction of the second picture. In other words, in contrast to predictive residual coding schemes, according to embodiments, the reconstructed second picture 52 may be directly determined using the restored representation 42 of the first picture and the motion description 26, e.g., only.

According to an embodiment, the second picture 19 is part of a plurality of second pictures which follow the first picture in the sequence 16 of pictures. For example, the plurality of second picture may be dependently coded pictures, e.g., encoded with reference to the first picture 18. For example, each of the plurality of second picture is encoded into the data stream 14 in the manner as described with respect to the second picture 19 above. In other words, for each of the plurality of second pictures, the data stream may be signaled a respective motion description, and decoder 11 may reconstruct the second pictures based on a representation of the first picture 18 and the motion description of the respective second picture, e.g., as described with respect to the second picture 19 above. The representation of the first picture 18 used for reconstructing the second pictures may change from second picture to second picture, as will be described in more detail below.

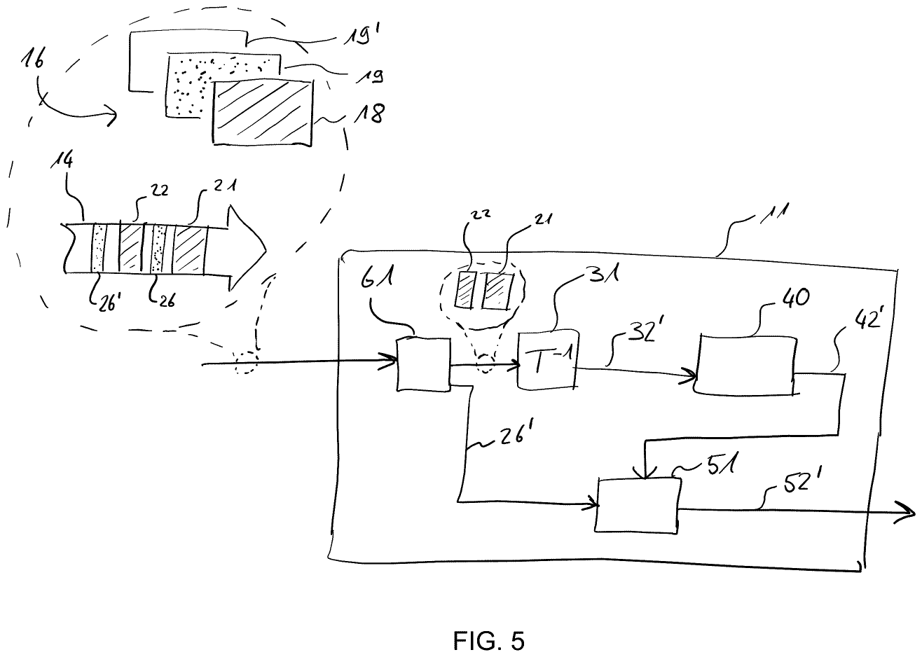

FIG. 5 illustrates the reconstruction of a further second picture 19′, which is part of the plurality of second pictures. According to this embodiment, the second group 22 of the channels of the first picture is associated with the further second picture 19′ out of the plurality of second pictures. That is, for example, the further second picture 19′ is reconstructed based on a representation of the first picture, which representation is derived using the second group, or, more precisely, the representation used for reconstructing the further second picture 19′ differs from the representation of the first picture used for reconstructing a directly preceding second picture out of the plurality of second picture in that the second group 22 is used for deriving the representation used for reconstructing the further second picture 19′ differs in addition to channels of the transformed representation of the first pictures, which were used for deriving the representation used for reconstructing the second picture 19.

In the reconstruction of the further second picture illustrated in FIG. 5, decoding unit 61 decodes, from the data stream 14, the second group 22 of channels and a motion description 26′ for the further second picture 19′. The first group 21 and the second group 22 are subjected, e.g., jointly subjected, to the transform 31 to obtain a further reconstructed representation 32′ of the first picture. Decoder 11 subjects the further reconstructed representation 32′ to the restoration model 40 to obtain a further restored representation 42′ of the first picture 18. The further reconstructed representation 42′ is then input for the motion decoder 51, which reconstructs the further second picture 19′ based on the further restored representation 42′ of the first picture 18 and the motion description 26′ of the further second picture 19′. For example, the motion decoder 51 reconstructs the further second picture 19′ as described with respect to the second picture 19, except for using, as an input, the further restored representation 42′ of the first picture 18 instead of the restored representation 42 and the further motion description 26′ instead of the motion description 26.

In other words, according to the embodiment of FIG. 5, the plurality of groups of channels of the transformed representation of the first picture comprises the first group 21 and at least one second group 22.

According to an embodiment, the plurality of groups comprises, or consists of the first group 21 and one or more second groups 22, the one or more second groups comprising the second group. According to this embodiment, the second picture 19 is part of a plurality of second pictures which follow the first picture 18 in the sequence 16 of pictures. According to this embodiment, each of the second groups 22 is associated with a respective further second picture 19′ out of the plurality of second pictures. The decoding unit 61 may decode, e.g., sequentially decode, from the data stream 14, the one or more second groups 22, and for each of the one or more second groups, a further motion description 26′ for the respective associated further second picture 19′. For example, decoding unit 61 may sequentially decode pairs of one of the second groups 22 and the further motion description 26′ of its associated further second picture 19′. In other words, in the data stream, the motion descriptions 26, 26′ for the plurality of second pictures 19, 19′ may be interleaved with the one or more second groups 22 of channels.

The reconstruction of each of the second pictures may be performed as described for the further second picture 19′ with respect to FIG. 5. In other words, decoder 11 may, for each of the one or more second groups 22, obtain a further reconstructed representation 32′ of the first picture by subjecting the first group 21 and the respective second group 22 to the transform 31. For example, the further reconstructed representation 32′ for the currently reconstructed second picture is obtained by subjecting the first group 21 and all already decoded second groups 22 in the sequence of the one or more second groups up to the respective second group to the transform, e.g., jointly. Decoder 11 may subject the further reconstructed representation 32′ to the restoration model 40 to obtain a further restored representation 42′ of the first picture, and decoder 11 may reconstruct the further second picture 19′ based on the further restored representation 42′ of the first picture and the motion description 26′ of the further second picture.

In other words, decoder 11 may alternatingly receive the second groups and the motion description for the second pictures until all groups of the plurality of groups were received, and decoder 11 may update the reconstructed and restored representation 42′ used for reconstructing a second picture using the second group received immediately before the motion description of the respective second picture.

For example, after having received all groups, decoder 11 may reconstruct further pictures of the sequence 16 using the last updated restored representation 42′ derived on the basis of all of the groups.

Thus, the quality of the reconstructed representation 32′, and thus of the restored representation 42′ may increase during the progress of receiving the second groups and updating the reconstructed representation 32′. For example, the updating may be performed by recalculation.

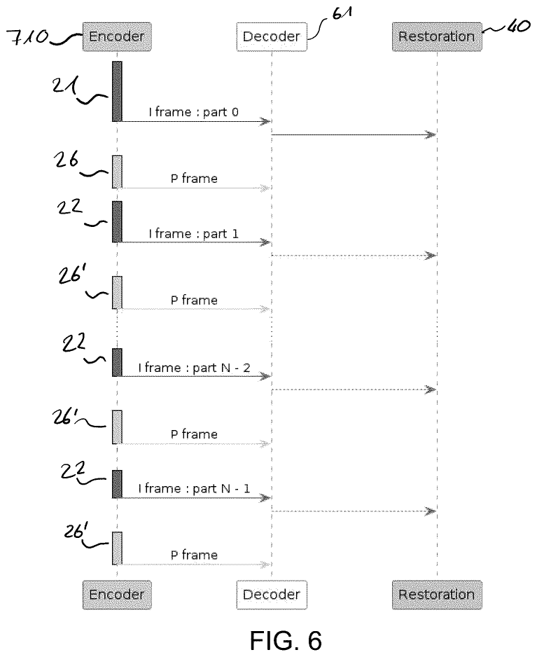

FIG. 6 illustrates a sequence diagram of decoder 11 according to an embodiment, e.g., according to an example of the embodiments as described with respect to FIG. 5. As illustrated in FIG. 6, an encoder 710, such as, for example, but not limited to, encoder 10, which will be described below, may encode an I-frame into a number of N groups 0 to N−1, which may be transmitted to decoder 11 by interspersing the groups with the encoded P-frames, thereby distributing the payload for signaling the I-frame over the duration of N frames.

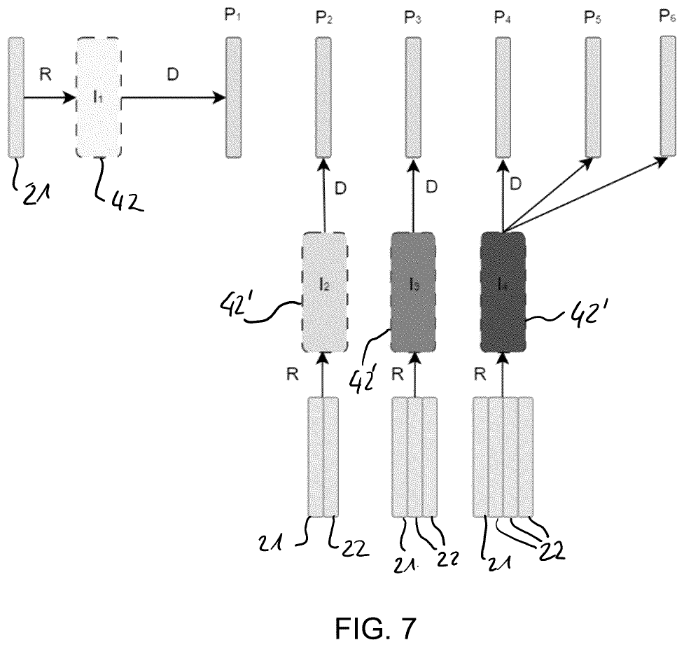

FIG. 7 illustrates an embodiment of the progressive I-frame reconstruction, in which the transformed representation of the first picture, e.g., an I-frame, is split into a number of four groups, e.g., the first group 21 and three second groups 22. In FIG. 6, the transform 31 may be referred to as decoding D, illustrated as arrow in FIG. 1, and the restoration 40 is illustrated as arrow labeled R. The second pictures are referred to as P1 to P6. According to this embodiment, at first, the first part 21 of the I-frame is decoded using an I-frame decoder, e.g., the transform 31, and restored using the image-restoration network, e.g., the restoration model 40, resulting in a restored representation 42, labeled I1, of the I-frame. I1 is used to reconstruct frame P1. The second part 22 then received is, together with the first part 21, decoded and restored to yield I2. I2 is used to reconstruct P2 frame. The 3rd part is received and, together with the first two parts, decoded and restored to yield I3. I3 is used to reconstruct P3 frame. The 4th part is received and, together with the first three parts, decoded and restored to yield I4. I4 is used to reconstruct P4 frame. All subsequent P frames are reconstructed using I4. In other words, the presented example uses the four groups of the I-frame latent to refine the I-frame over four steps, each intermediate I-frame reconstruction is used to animate the corresponding P-frame.

Although in the shown example all received I-frame parts are used for progressively refining the reconstruction of the I-frame, in other examples, the decoder may use only a subset thereof. Both options may be implemented in any of the embodiments described above.

As becomes clear from the above description, for example, the higher the number of the one or more second groups, the more evenly may the payload of the transformed representation of the first picture be distributed within the data stream signaling the sequence 16. On the other hand, the more second groups, the longer it takes until the transformed representation is fully transmitted.

In the following, embodiments of the transform 31 are described. The details and features described in the following may be combined with any of the embodiments described above with respect to FIG. 4 to FIG. 7.

According to an embodiment, all channels of groups which have not yet been received may be set to predetermined values, e.g., zero. In other words, the transform 31 may be performed in the same manner for all iterations of deriving the reconstructed representation 32 and the further reconstructed representation 32′, but the input data may differ in that unavailable channels may be set to a predetermined value.

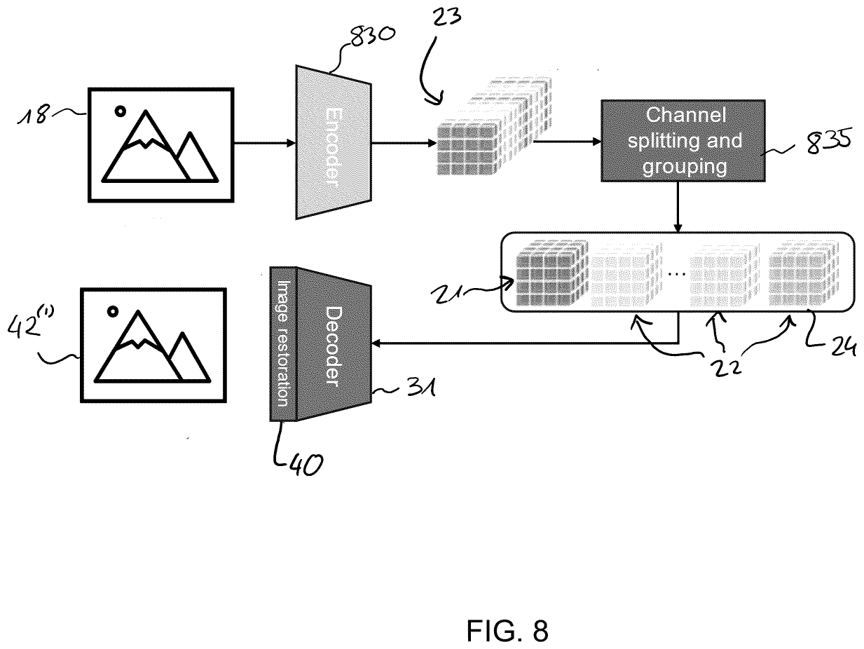

FIG. 8 illustrates a learning-based coding scheme according to an embodiment. According to this embodiment, the non-linear transform 31 is performed by a machine learning model, e.g., referred to as decoder model or decoder network. For example, the first picture 18 may be encoded into the data stream by subjecting the first picture 18 to a machine learning model 830, e.g., referred to as encoder or encoder model or encoder network to obtain the transformed representation, referred to with reference sign 23 in FIG. 8, e.g., a latent representation. For example, each of the channels of the transformed representation 23 may correspond to the output of an output channel of the encoder model 830. For example, each of the channels comprises, or consists of, an array of transform coefficients, or latent variables, or features, each having a value associated therewith. On encoder side, such as by examples of encoder 10 described later, the plurality of channels may be split and grouped to obtain the plurality of groups, referred to with reference sign 24 in FIG. 8, and the groups may be encoded into the data stream, e.g., as described before. On decoder side, such as in examples of decoder 11, the transformed representation 23, or an available portion thereof, may be subjected to decoder model 31, the output of which may be fed to the restoration model 40 to obtain the restored representation 42, 42′ of the first picture 18.

For example, the decoder model and the encoder model each comprise a neural network.

In other words, according to an embodiment, the transform 31 is a synthesis transform, e.g., the transform comprises a neural network, e.g., a DNN.

For example, the encoder network and the decoder network may be learned neural networks, e.g., end-to-end learned, e.g., learned by minimizing a distortion between the original picture and the reconstructed picture, or a rate-distortion relation for transmitting the picture.

For example, the first picture 18 may be of the dimension 3×H×W, where H is the height in pixels, W is the width in pixels, and a number of components, e.g., luma and chroma, or color planes, is three.

For example, the transformed representation 23, into which encoder model 830 encodes the first picture, may have a dimension of c×h×w, with c denoting the number of channels, and h×w the dimension of each of the channels in height and width.

In other words, FIG. 8 may illustrate an example for a learning-based I-frame codec with channel grouping and image-restoration block.

According to an embodiment, each of the plurality of channels of the transformed representation is associated with one of a plurality of input channels of the transform, e.g., is input for the associated input channel in performing the transform 30.

According to an embodiment of decoder 11, decoder 11 may derive the indication of the distribution of the channels to the groups from the data stream, and use the indication to associate the channels signaled in the groups to the channels of the transformed representation to be input to the transform 30.

As to the decoding unit 61, according to an embodiment, which may optionally be combined with any of the embodiments described above, the decoding unit 61 decodes the first group 21 from the data stream using entropy decoding. Optionally, also the motion description 26, 26′ may be decoded using entropy decoding.

In the following, optional details of the restoration model 40 are described. The details and features described in the following may be combined with any of the embodiments described above with respect to FIG. 4 to FIG. 8.

According to an embodiment, the restoration model is a machine learning model, taking as input the reconstructed representation 32, 32′ and providing as output the restored representation 42, 42′. For example, the restoration model may be trained for specific applications, such as video conferencing. For example, the restoration model may be trained on faces, i.e., to restore pictures showing a face.

According to an embodiment, the restoration model is a restoration neural network, e.g., as known by one skilled in the art.

For example, restoration neural networks as referred to herein, aim at improving the quality of a degraded image under known or unknown degradations [4]. For example, unlike image coding which tries to reconstruct the output as close to the source image in pixel fidelity terms, image restoration aims at improving the picture quality of the image to be restored by addressing deblurring, denoising, dehazing and super-resolution aspects.

As general image restoration networks can be complex, they are sometimes used only as a post-processing module for the output of an image/video decoder for archiving or offline applications. A common example are super-resolution networks which can increase the output resolution of a video decoder. For example, if the input image is a face-image, face-restoration neural network can be used to improve the face-image quality [5]. In general, the restoration model may be specifically trained for the application, i.e., for the characteristics of the content of the video to be transmitted.

Due to the computationally expensive nature of restoration networks, they are usually not used in the decoding loop of a video codec. In contrast, embodiments of the invention exploit the quality gain provided by a restoration model, while keeping the computational cost low, e.g., by applying the restoration model to the I-frame only, i.e., only one time per group of pictures or only as many times as the I-frame is updated per group of pictures.

Embodiments of the present invention provide a way to benefit from quality recovery capability of an image/face-restoration networks by employing it in the decoding loop. In particular, using the restoration model for the first picture, the I-frame, from which dependently coded picture depend, improves the quality of all reconstructed pictures of the sequence 16 even if only applying the restoration model to the reconstructed representation of the first picture. In other words, applying the restoration neural network only to the I-frames of a video, (e.g., and not the parametrically, or dependently, coded frames), keeps the operational complexity of the decoder at a relatively low or reasonable level, while providing a quality improvement for the entire sequence.

In other words, to circumvent the high computational complexity of an image-restoration network, the actual restoration task may be performed only on the I-frame and not on the P frames (so a few times in a GOP). This will lead to a significantly lower “operational” complexity of the image-restoration network inside the video decoding framework, e.g., as compared to applying the network to all frames.

In yet other words, at the decoder, according to embodiments, an image-restoration network for in-loop decoding is employed to recover the loss in image quality due to using the partial latent space of the I-frame.

For example, the restoration model is a trained model, which is trained for progressive frame reconstruction, e.g., by providing, as training samples, reconstructed representations of pictures, which were reconstructed using only a subset of channels of their transformed representations, and training the model to minimize a distortion between the restored representation and the original picture.

In other words, since the degradation type is fixed by the image codec, a dedicated image-restoration network can be trained only targeting the image compression degradations. Since an image-restoration network targeting a specific distortion is much shallower compared to a general image-restoration targeting any arbitrary distortion type, this can lead to a significantly lower actual complexity of the restoration network.

In other words, according to an embodiment, the decoder 11 is configured for outputting the reconstructed representation 52, 52′ of the second pictures without using a restoration model for deriving the outputted reconstructed representations.

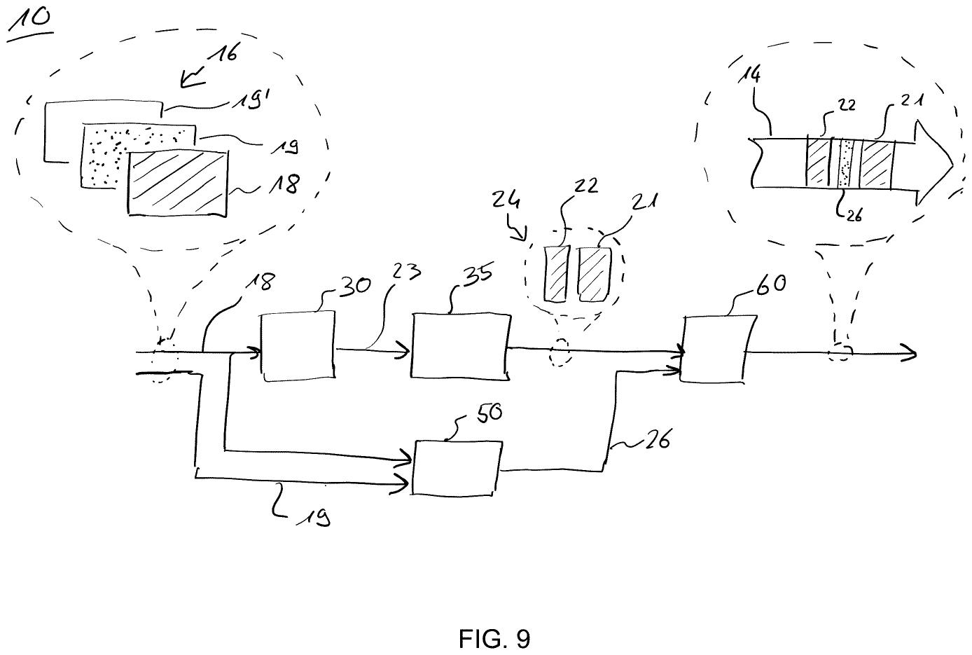

FIG. 9 illustrates an apparatus 10 for encoding a sequence 16 of pictures into a data stream 14 according to an embodiment. Apparatus 10 may be referred to as encoder 10. Encoder 10 transforms a first picture 18 of the sequence 16 of pictures using a non-linear transform 30 to obtain a transformed representation 23 of the first picture 18, the transformed representation 23 comprising a plurality of channels. Encoder 10 comprises a channel distributor 35, which distributes the channels to a plurality of groups 24 in dependence on the plurality of channels. For example, the channel distributor 35 determines a distribution of the channels to the groups in dependence on the plurality of channels, that is, e.g., by evaluating the plurality of channels regarding an evaluation criterion and using the evaluation criterion for deriving the distribution. According to the embodiment of encoder 10 of FIG. 9, the plurality of groups comprises, or consists of a first group 21 and one or more second groups 22. Encoder 10 further comprises an encoding unit 60, configured for inserting the first group 21 into the data stream 14. Encoder 10 further comprises a motion encoder 50, which derives, based on the first picture 18, for each of a plurality of second pictures 19, 19′ of the sequence of pictures, which follow the first picture in the sequence of pictures, a motion description 26. Encoding unit 60 encodes, e.g., sequentially encodes, the motion descriptions 26 of the second pictures and the second groups 22 into the data stream by interleaving the motion descriptions 26 of the second pictures with the one or more second groups 22, e.g., as already described above with respect to data stream 14 decoded by decoder 11.

It is noted that as far as same terms and/or same reference numerals are used as in the foregoing description of decoder 11, the description of the respective features may optionally also apply to the encoder 10, in particular, as far as the sequence 16, the first picture 18, the second pictures 19, 19′, the transformed representation and the channels thereof, the groups 21, 22, and the motion description 26 is concerned. Furthermore, the skilled person will understand that the transform 30 and the transform 31 may be related to each other in that the transform 31 undoes the transform 30. In examples, the transform 31 of decoder 11 may be the inverse of the transform 30 of encoder 10, however, this is not necessarily exactly the case, in particular, in case that the transforms 30, 31 are end-to-end learned machine learning models.

Regarding the relationship between signals described at decoder-side to those at the encoder side, it is further noted, that the disclosed coding scheme is not limited to embodiments, in which the transformed representation encoded by encoder 10 corresponds exactly to the transformed representation decoded from the data stream by decoder 11, but, in alternative embodiments, some or all signals decoded from data stream 14, such as the channel groups and/or the motion descriptions, may include coding loss, for example, introduced by an additional quantization step, which may optionally be employed by encoder 10 prior to the encoding 60, e.g., to the channels of the transformed representation and/or the motion descriptions. Furthermore, it is noted that the determination of the distribution of channels to groups as described with respect to encoder 10 is optional for the decoder 11, and decoder 11 may also operate on data streams generated differently as the one described with respect to encoder 10, for example, a data stream generated using a default assignment of channels to groups.

As to the non-linear transform 30, according to an embodiment, the transform 30 may be an analysis transform, e.g., comprising a neural network, e.g., a DNN. For example, the transform 30 may correspond to transform 830 described with respect to FIG. 8.

As to the motion encoder 50 and the motion description 26 provided by motion encoder 50, reference is made to the description of motion decoder 40 of decoder 11. Motion encoder 50 may generate the motion description, e.g., by comparing the second picture, for which the motion description is to be generated to the first picture.

As to the encoding unit 60, according to an embodiment, the encoding unit 60 may encode the groups of the transformed representation 23 and/or the motion descriptions 26 using entropy encoding.

In the following, optional details and features of the channel distributor 35 are described.

According to an embodiment, channel distributor 35 is configured for distributing the channels of the transformed representation to the plurality of groups by determining, for each of the channels or for each of a subset of the channels, a predetermined measure. According to this embodiment, channel distributor 35 distributes the channels to the groups in dependence on the predetermined measure determined for the channels or the subsets of channels.

According to an embodiment, the predetermined measure is an estimate of a size for transmitting the respective channel, e.g., data size, e.g., size in bits. For example, the predetermined measure may be an entropy measure for the channel, e.g., a size of an entropy-encoded representation of the respective channel.

In other words, in the transformed representation 23, each channel contributes a certain amount to the total transmitted bitrate. According to an embodiment, the bitrate contribution of each channel is measured using an entropy measure, e.g., an entropy measure as described in [6]. Using the entropy measure allows the channel distributor 35 to distribute the channels in a way to reduce the variation of the bitrate, and/or finding an improved tradeoff between a more constant bitrate and a high quality of the reconstruction of the first frames of the sequence.

According to an alternative embodiment, the predetermined measure is a measure for a contribution of the respective channel to the first picture, e.g., an energy measure.

For example, the predetermined measure is a measure of an effect of the channel to a reconstruction quality of reconstructing the first picture from the transformed representation. For example, the reconstruction quality may be measured in terms of distortion, such as a distance metric and/or a criterion that takes a perception of certain types of distortion by the human into account, such as a different perception of components of high spatial frequency compared to components of low-frequency.

According to an embodiment, the energy measure is determined as a metric, e.g., the average of x\hat{ }2, over the features (coefficient values) x of the respective channel.

According to an embodiment, each of the groups comprises, or consists of, the same number, e.g., count, of channels. For example, the channels representing all components of the first picture, e.g., both luminance and chrominance information, are sorted in the decreasing order of the predetermined measure, e.g., entropy, and grouped into N groups, each consisting of an equal number of channels.

According to an embodiment, the first picture is a multi-component picture. For example, the first picture may comprise a, luma and one or more, e.g. tow, chroma components, or the first picture may comprise three color components, such as RGB. According to this embodiment, the plurality of channels comprises a plurality of first channels for a first component of the first picture 18 and a plurality of second channels for a second component of the first picture 18. In distributing the plurality of channels to the plurality of groups, channel distributor 35 may assign the plurality of first channels to one of the groups, e.g., to exactly one, e.g., all to the same one of the groups, and channel distributor 35 may determine, for each of the second channels, the predetermined measure, and channel distributor 35 may distribute the second channels to the plurality of groups in dependence on the predetermined measure.

In other words, for example, according to an embodiment, in which different components are treated differently, e.g., if the encoder processes luminance and chrominance components separately, only the second channels, e.g., luminance components, are considered for progressive transmission, i.e., are distributed to multiple groups, while the first channels, e.g., chrominance components is sent in one group. For example, according to this embodiment, the second channels, e.g., the luminance components can be split into N groups with the following alternative strategies:

According to a first variant, the encoder 10 inserts the plurality of groups into the data stream according to an order from lower to higher ranks defined among the plurality of groups. For example, the encoder 10 inserts a group of lower rank prior to a group of higher rank. According to this embodiment, the channel distributor distributes the channels to be distributed, e.g., all channels or the subset of channels, e.g., the luma components, by assigning a channel of higher entropy or energy to a group of lower rank of the order defined among the plurality of groups. E.g., channel distributor assigns a first channel, having a higher entropy of energy than a second channel, to a group having a lower rank than a group, to which the second channel is assigned.

In other words, for example, each group can contain a variable number of channels. Each group contributes the same or similar bitrate. The first group has the channels contributing most important features in terms of decoded image quality, e.g., the above-described energy measure. For example, a bitrate threshold Rate/N is used for each group of channels. The same threshold may be used for all groups.

According to a second variant, for example, channel distributor 35 sorts the channels to be distributed according to the predetermined measure to obtain an order among the channels, and assigns each of the channels to be distributed to one of a set of groups out of the plurality of groups, to which set of groups the channels to be distributed are to distributed (e.g., the set of groups comprising all of the plurality of groups or a subset thereof, e.g., a subset thereof on which the channels to be distributed, e.g., the second channels, e.g., the luma channels, are to be distributed). To this end, channel distributor may assign, sequentially according to the order among the channels, each of the channels to be distributed to the group with the least size within the set of groups. For example, in case of multiple groups having the least size, channel distributor 35 may select one of the groups having the least size according to an order defined among the groups.

In other words, for example, each group can contain the same number of channels—M. The channels are sorted based on their bitrate, e.g., the above-mentioned entropy measure, and put into the group with the least bitrate sum.

According to a third variant, channel distributor 35 distributes the channels to the plurality of groups such that each of the groups carries a respective predetermined share of a size of the transformed representation, e.g., data size, size in terms of bits. For example, the size refers to the size of the transformed representation or the size of an entropy encoded representation of the transformed representation. For example, the respective predetermined shares may be equal or different between the groups.

In other words, for example, each group can contain a variable number of channels. The first group contributes 50 percent of the encoded frame size (in terms of bits) compared to other groups. The other groups contributed dyadically half the frame size, 25%, 12.5%, 6.25%, and so on. Alternatively, a different set of percentages can be defined for each group.

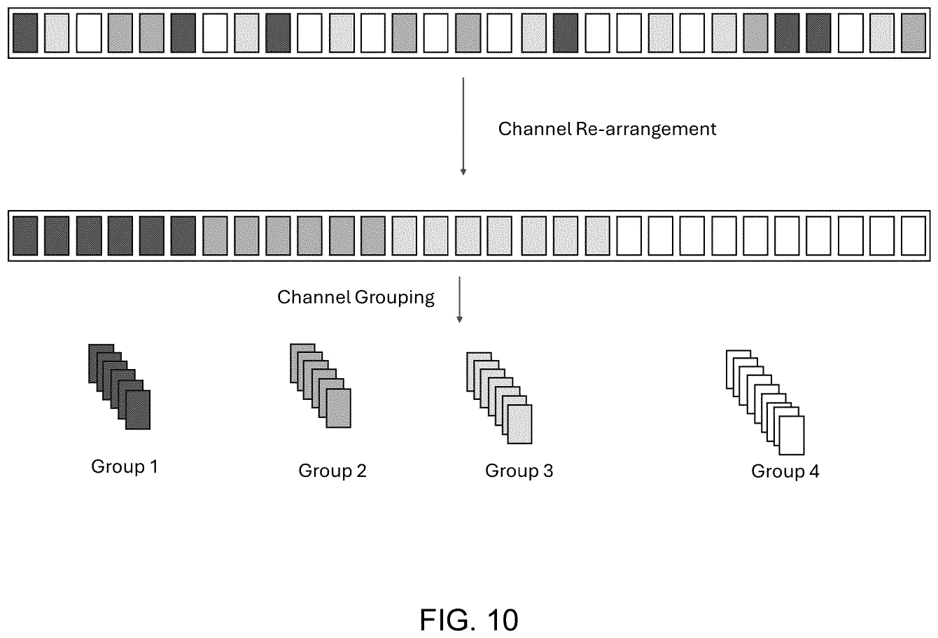

FIG. 10 illustrates an example of the channel distributor 35, according to an embodiment, in which a sorting of channels is performed. For example, in FIG. 10, different greyscales show different entropy for channels. First a channel sorting is performed based on a certain criterion, such as energy or entropy. Then different thresholds can be used to group the channels, e.g. using groups of equal size in terms of bitrate or in terms of equal number of channels, or certain shares per group, e.g., as described above.

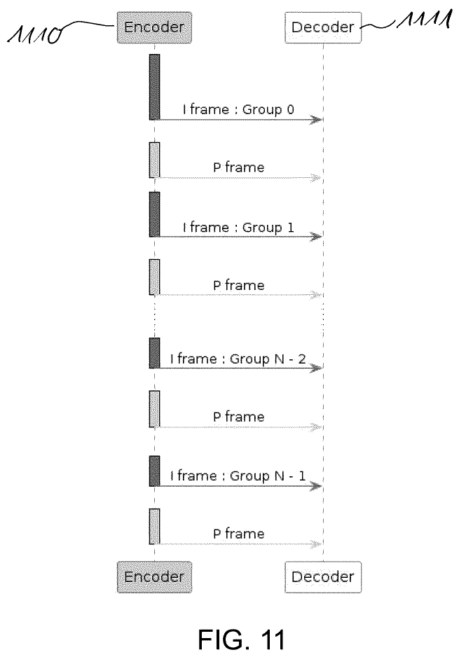

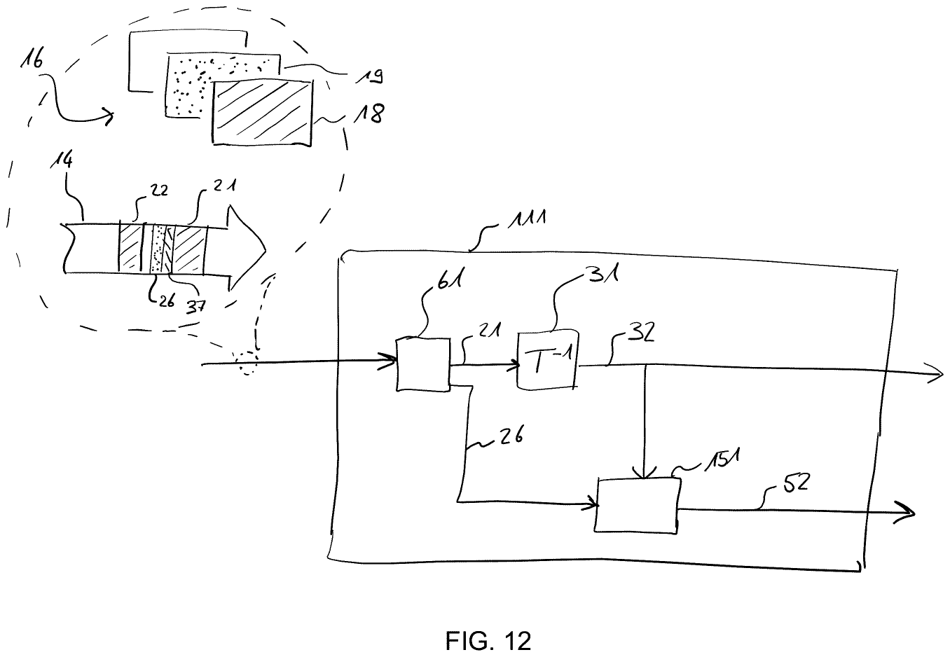

FIG. 11 shows a sequence diagram for an embodiment of a progressive I-frame reconstruction. For example, encoder 1110 of FIG. 11 may correspond to encoder 10 of FIG. 11, and decoder 1111 may correspond to decoder 111, which will be described below with respect to FIG. 12. For example, the embodiment of FIG. 11 may differ from the embodiment of FIG. 7 merely in that the decoder directly uses reconstructed representations of the I-frame for reconstructing the P-frames, e.g., without using a restoration model.

In the following, further optional details and features of encoder 10 of FIG. 9 are described, which may be combined with any of the previously described features.

According to an embodiment, encoder 10 may insert an indication of the distribution of the channels to the groups into the data stream. For example, encoder 10 may signal, along with a group, e.g., along with each of the groups, an indication that indicates the channels included in the groups. Alternatively, the indication may be signaled together with the first group 21.

FIG. 12 illustrates an apparatus 111 for decoding, or reconstructing, a sequence of pictures 16 from a data stream 14 according to another embodiment. The description of decoder 11 and its components as provided above may equivalently apply to decoder 111 of FIG. 12, however, decoder 111 of FIG. 12 reconstructs the second picture 19 based on the reconstructed representation 32 of the first picture, as provided by the non-linear transform 31. For example, motion decoder 151 of decoder 111 may apply the motion descrition 26 to the reconstructed representation 32 to obtain the reconstructed second picture 52. In other words, decoder 111 may directly use the reconstructed representation 32 as input for reconstructing the second picture 19, e.g., without using a restoration model for restoring the reconstructed representation. According to the embodiment of FIG. 12, each of the plurality of channels of the transformed representation is associated with one of a plurality of input channels of the non-linear transform 31, and decoder 111 is configured for deriving, from the data stream 14, an indication 37 of the input channels with which the channels of the first group 21 are associated.

According to an embodiment, decoder 111 is configured for deriving, from the data stream 14, an indication 37 of the input channels with which the channels of the second group 21 are associated.

In other words, the selection of channels out of the plurality of channels of the transformed representation, which selection is included in the indivual group, e.g., the first group and the one or more second groups, is not necessarily predefined, but may be determined on encoder side, e.g., as described with respect to encoder 10, and signaled in the data stream 14, so that the decoder 111 can assign the channels invluded in the individual groups to the input channels of the transform 31. Thus, decoder 111 may form a counterpart of encoder 10 described above. In other words, decoder 111 may allow a flexible distribution of the channels to the plurality of groups.

In the following, further optional details and features are described, which may be combined with any of the embodiments of encoder 10 and decoder 11 or decoder 111.

According to an embodiment, encoder 10 transmits the encoded data stream via a wireless communication path or communication channel, for example, via a satellite. For example, the wireless communication path may have a low capacity, e.g., channel capacity, such as lower than 50 kbps or lower than 20 kbps or lower than 10 kbps.

According to an embodiment, decoder 11, 111 may perform the decoding online or offline.

In the following, further advantages, details and optional features of embodiments are described:

In a neural network-based video codec usually the following conflicting requirements exist:
(1) I-frames are expensive in terms of bitrate, so encode as few as possible in a given bitstream to yield a minimum average bitrate
(2) I-frames control the quality of reconstructed P-frames so encode I-frame at a fairly high quality
(3) Reconstruction quality drops if a P-frame is far away from the previous I-frame so keep the GOP size small
(4) In case of occlusions, accurate reconstruction of P-frames is not possible without making ghosting distortions, so encode I-frames when occlusions occur.

Requirements (1) and (3) are in direct conflict with each other and requirement 2 leads to high bitrate peaks when an I-frame is encoded. Requirement 4 suggest encoding an I-frame every time an occlusion happens. For example, since for a general messaging or conferencing application head or hand movements yield occlusions, transmission of an I-frame for each such instance can lead to a high average bitrate.

The disclosed embodiments provide tools to address the conflicting requirements (listed in the previous section) of a low bitrate parametric video coding system. Some embodiments use channel reordering and splitting technique to split I-frame latent space into number of groups (parts) that are transmitted sequentially instead of jointly in one-go. The first part of the I-frame will be sent as a first frame in the GOP while remaining parts of an I-frame are transmitted together with the subsequent parametrically encoded P-frames. The number of parts an I-frame is split can be any number N where N<=GoP_size. Moreover, N can vary from one GOP to the other.

For example, a decoder according to an embodiment may perform the following steps:
Decoding of a video bitstream representing sequences of pictures, which contains intra-frames: an intra-frame (or I-frame) representing an independently decodable picture from a sequence of pictures (e.g., can be decoded disregarding information from other pictures in the sequence of pictures), and inter-frames: an inter-frame is a frame encoded using an I-frame as reference, where:
   a. Where each independently decodable picture is obtained from a non-linear transformation to reconstruct the picture from a subset of the codestream representing a first group of channels (e.g., this subset of the codestream is usually an encoded representation of the latent space of a network);
   b. Where each dependently decodable picture is obtained from the first subset of the codestream (e.g., from a.) and one or more additional groups of channels, reconstructing this first group and the additional groups by a non-linear transformation into an intermediate picture;
   i. Where this intermediate picture is further enhanced by a non-linear transformation to a recovered frame through a non-linear recovering network;
   ii. Where the decoded picture is obtained from the recovered picture (e.g., from i) and a first independently decodable set of control data that is identical for each dependently decodable picture depending on the same independently decodable picture, and a dependently decodable set of control data (e.g., which is associated to the timestamp of the target dependently decodable picture).
Optionally, the channels are grouped according to their entropy, such that channels of largest entropy are transmitted prior to channels with lower entropy, or, as an alternative option, the channels are grouped according to their energy (e.g., average of x\hat{ }2 over the feature space) such that channels of the largest energy are transmitted prior to channels with lower energy.

It is noted that the block diagrams of FIG. 4 and FIG. 9 may alternatively be considered as illustrations of respective methods, in which each of the blocks represents a step of the respective method.

Thus, what is further disclosed with respect to FIG. 4 is a method for decoding a sequence 16 of pictures from a data stream 14, the method comprising the following steps: decoding 61, from the data stream 14, a first group 21 of channels of a transformed representation of a first picture 18 of the sequence of pictures, wherein the transformed representation comprises a plurality of channels, the plurality of channels being distributed to a plurality of groups comprising the first group and a second group; obtaining 31 a reconstructed representation 32 of the first picture by subjecting the first group of channels to a transform, the transform being non-linear; subjecting 40 the reconstructed representation to a restoration model to obtain a restored representation 42 of the first picture; decoding 61, from the data stream, a motion description 26 of a second picture 19, which follows the first picture 18 in the sequence of pictures, and reconstructing 51 the second picture based on the restored representation 42 of the first picture and the motion description 26 of the second picture.

With respect to FIG. 9, what is further disclosed is a method for encoding a sequence 16 of pictures into a data stream 14, the method comprising the following steps: transforming a first picture 18 of the sequence of pictures using a non-linear transform 30 to obtain a transformed representation 23 of the first picture 18, the transformed representation 23 comprising a plurality of channels; distributing 35 the channels to a plurality of groups 24 in dependence on the plurality of channels, wherein the plurality of groups comprises a first group 21 and one or more second groups 22; inserting 60 the first group 21 into the data stream; deriving, based on the first picture, for each of a plurality of second pictures 19, 19′ of the sequence of pictures, which follow the first picture in the sequence of pictures, a motion description; and encoding the motion descriptions of the second pictures and the second groups into the data stream by interleaving the motion descriptions of the second pictures with the one or more second groups.

With respect to FIG. 12, what is further disclosed is a method for decoding a sequence 16 of pictures from a data stream 14, the method comprising: decoding 61, from the data stream 14, a first group 21 of channels of a transformed representation of a first picture 18 of the sequence of pictures, wherein the transformed representation comprises a plurality of channels, the plurality of channels being distributed to a plurality of groups comprising the first group and a second group; obtaining 31 a reconstructed representation 32 of the first picture by subjecting the first group of channels to a transform, the transform being non-linear; decoding 61, from the data stream, a motion description 26 of a second picture 19, which follows the first picture 18 in the sequence of pictures; and reconstructing 151 the second picture based on the reconstructed representation 42 of the first picture and the motion description 26 of the second picture. Eeach of the plurality of channels of the transformed representation is associated with one of a plurality of input channels of the non-linear transform, and the method comprises deriving, from the data stream, an indication of the input channels with which the channels of the first group are associated.

Although some aspects have been described as features in the context of an apparatus it is clear that such a description may also be regarded as a description of corresponding features of a method. Although some aspects have been described as features in the context of a method, it is clear that such a description may also be regarded as a description of corresponding features concerning the functionality of an apparatus. In particular, block diagrams illustrating an apparatus may also be regarded as illustration of a respective method comprising the steps described by the blocks of the block diagram.

Some or all of the method steps may be executed by (or using) a hardware apparatus, like for example, a microprocessor, a programmable computer or an electronic circuit. In some embodiments, one or more of the most important method steps may be executed by such an apparatus.

The inventive encoded image signal can be stored on a digital storage medium or can be transmitted on a transmission medium such as a wireless transmission medium or a wired transmission medium such as the Internet. In other words, further embodiments provide a video bitstream product including the video bitstream according to any of the herein described embodiments, e.g. a digital storage medium having stored thereon the video bitstream.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

In the foregoing Detailed Description, it can be seen that various features are grouped together in examples for the purpose of streamlining the disclosure. This method of disclosure is not to be interpreted as reflecting an intention that the claimed examples need more features than are expressly recited in each claim. Rather, as the following claims reflect, subject matter may lie in less than all features of a single disclosed example. Thus the following claims are hereby incorporated into the Detailed Description, where each claim may stand on its own as a separate example. While each claim may stand on its own as a separate example, it is to be noted that, although a dependent claim may refer in the claims to a specific combination with one or more other claims, other examples may also include a combination of the dependent claim with the subject matter of each other dependent claim or a combination of each feature with other dependent or independent claims. Such combinations are proposed herein unless it is stated that a specific combination is not intended. Furthermore, it is intended to include also features of a claim to any other independent claim even if this claim is not directly made dependent to the independent claim.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] Goluck Konukoy, Giuseppe Valenzisez, Stéphane Lathuilière, Ultra-Low Bitrate Video Conferencing Using Deep Image Animation, ICASSP 2021.
[2] Thomas Wiegand, Gary J. Sullivan, Gisle Bjøntegaard, and Ajay Luthra, Overview of the H.264/AVC Video Coding Standard, IEEE Transactions of Circuit and Systems for Video Technology, 2003.
[3] Haoming Chen, Chen Zhao, Ming-Ting Sun, Aaron Drake, Adaptive intra-refresh for low-delay error-resilient video coding, ELSEVIER, Journal of Visual Communication and Image Representation, 2015.
[4] Jingwen Su, Boyan Xu, Huiun Yin, A survey of deep learning approaches to image restoration, ELSEVIER Neurocomputing, 2022.
[5] Tao Wang, Kaihao Zhang, Xuanxi Chen, Wenhan Luo, Jiankang Deng, Tong Lu, Xiaochun Cao, Wei Liu, Hongdong Li, Stefanos Zafeiriou “A Survey of Deep Face Restoration: Denoise, Super-Resolution, Deblur, Artifact Removal,” arXiv preprint arXiv: 2211.02831, 2022.
[6] Srivatsa Prativadibhayankaram, Thomas Richter, Siegfried Föβel, André Kaup, “Latent channel energy in learned image codecs,” Proc. SPIE 13137, Applications of Digital Image Processing XLVII, 2024.
[7] Dequan Yu, Johannes Sauer, Timofey Solovyev, Yin Zhao, Elena Alshina, “wg1m103040-CPM-[JPEG AI CE] Report on CE7.4 Progressive decoding”, ISO/IEC JTC 1/SC 29/WG 1, 2024.

1. An apparatus for decoding a sequence of pictures from a data stream, configured for
decoding, from the data stream, a first group of channels of a transformed representation of a first picture of the sequence of pictures, wherein the transformed representation comprises a plurality of channels, the plurality of channels being distributed to a plurality of groups comprising the first group and a second group,
acquiring a reconstructed representation of the first picture by subjecting the first group of channels to a transform, the transform being non-linear,
subjecting the reconstructed representation to a restoration model to acquire a restored representation of the first picture,
decoding, from the data stream, a motion description of a second picture, which follows the first picture in the sequence of pictures, and
reconstructing the second picture based on the restored representation of the first picture and the motion description of the second picture.

2. The apparatus according to claim 1, wherein the second picture is part of a plurality of second pictures which follow the first picture in the sequence of pictures, wherein the second group is associated with a further second picture out of the plurality of second pictures, and
wherein the apparatus is configured for
decoding, from the data stream, the second group of channels and a motion description for the further second picture,
acquiring a further reconstructed representation of the first picture by subjecting the first group and the second group to the transform,
subjecting the further reconstructed representation to the restoration model to acquire a further restored representation of the first picture,
reconstructing the further second picture based on the further restored representation of the first picture and the motion description of the further second picture.

3. The apparatus according to claim 1, wherein the plurality of groups comprises the first group and one or more second groups, and wherein the second picture is part of a plurality of second pictures which follow the first picture in the sequence of pictures, wherein each of the second groups is associated with a further second picture out of the plurality of second pictures, and
decoding, from the data stream, the one or more second groups, and for each of the one or more second groups, a further motion description for the respective associated further second picture,
wherein the apparatus is configured for, for each of the one or more second groups,
acquiring a further reconstructed representation of the first picture by subjecting the first group and the respective second group to the transform,
subjecting the further reconstructed representation to the restoration model to acquire a further restored representation of the first picture,
reconstructing the further second picture based on the further restored representation of the first picture and the further motion description of the further second picture.

4. The apparatus according to claim 2, wherein each of the plurality of channels of the transformed representation is associated with one of a plurality of input channels of the transform,
wherein the apparatus is configured for deriving, from the data stream, an indication of the input channels with which the channels of the second group are associated.

5. The apparatus according to claim 1, wherein the transform comprises a neural network.

6. The apparatus according to claim 1, configured for decoding the first group from the data stream using entropy decoding.

7. An apparatus for encoding a sequence of pictures into a data stream, configured for
transforming a first picture of the sequence of pictures using a non-linear transform to acquire a transformed representation of the first picture, the transformed representation comprising a plurality of channels,
distributing the channels to a plurality of groups in dependence on the plurality of channels, wherein the plurality of groups comprises a first group and one or more second groups,
inserting the first group into the data stream, deriving, based on the first picture, for each of a plurality of second pictures of the sequence of pictures, which follow the first picture in the sequence of pictures, a motion description, and
encoding the motion descriptions of the second pictures and the second groups into the data stream by interleaving the motion descriptions of the second pictures with the one or more second groups.

8. The apparatus according to claim 7, configured for, in distributing the channels to the plurality of groups,
determining, for each of the channels or for each of a subset of the channels, a predetermined measure, and
distributing the channels to the groups in dependence on the predetermined measure.

9. The apparatus according to claim 7, wherein the first picture is a multi-component picture, and wherein the plurality of channels comprises a plurality of first channels for a first component of the first picture and a plurality of second channels for a second component of the first picture, and wherein the apparatus is configured for, in distributing the plurality of channels to the plurality of groups,
assigning the plurality of first channels to one of the groups, and
determining, for each of the second channels, a predetermined measure, and
distributing the second channels to the plurality of groups in dependence on the predetermined measure.

10. The apparatus according to claim 8, wherein the predetermined measure is an estimate of a size for transmitting the respective channel.

11. The apparatus according to claim 8, wherein the predetermined measure is a measure for a contribution of the respective channel to the first picture.

12. The apparatus according to claim 10, wherein the apparatus is configured for inserting the plurality of groups into the data stream according to an order from lower to higher ranks defined among the plurality of groups, and configured for distributing the channels to be distributed by assigning a channel of higher entropy or energy to a group of lower rank of the order defined among the plurality of groups.

13. The apparatus according to claim 7, wherein each of the groups comprises the same number of channels.

14. The apparatus according to claim 7, configured for
sorting the channels to be distributed according to the predetermined measure to acquire an order among the channels, and
assigning each of the channels to be distributed to one of a set of groups out of the plurality of groups, to which set of groups the channels to be distributed are to distributed by assigning, sequentially according to the order among the channels, each of the channels to be distributed to the group with the least size within the set of groups.

15. The apparatus according to claim 7, configured for distributing the channels to the plurality of groups such that each of the groups carries a predetermined share of a size of the transformed representation.

16. The apparatus according to claim 7, wherein the non-linear transform comprises a neural network.

17. The apparatus according to claim 7, configured for inserting the first group into the data stream using entropy encoding.

18. An apparatus for decoding a sequence of pictures from a data stream, configured for
decoding, from the data stream, a first group of channels of a transformed representation of a first picture of the sequence of pictures, wherein the transformed representation comprises a plurality of channels, the plurality of channels being distributed to a plurality of groups comprising the first group and a second group,
acquiring a reconstructed representation of the first picture by subjecting the first group of channels to a non-linear transform,
decoding, from the data stream, a motion description of a second picture, which follows the first picture in the sequence of pictures, and
reconstructing the second picture based on the reconstructed representation of the first picture and the motion description of the second picture,
wherein each of the plurality of channels of the transformed representation is associated with one of a plurality of input channels of the non-linear transform, and wherein the apparatus is configured for deriving, from the data stream, an indication of the input channels with which the channels of the first group are associated.

19. A method for decoding a sequence of pictures from a data stream, the method comprising:
decoding, from the data stream, a first group of channels of a transformed representation of a first picture of the sequence of pictures, wherein the transformed representation comprises a plurality of channels, the plurality of channels being distributed to a plurality of groups comprising the first group and a second group,
acquiring a reconstructed representation of the first picture by subjecting the first group of channels to a transform, the transform being non-linear,
subjecting the reconstructed representation to a restoration model to acquire a restored representation of the first picture,
decoding, from the data stream, a motion description of a second picture, which follows the first picture in the sequence of pictures, and
reconstructing the second picture based on the restored representation of the first picture and the motion description of the second picture.

20. A method for encoding a sequence of pictures into a data stream, the method comprising:
transforming a first picture of the sequence of pictures using a non-linear transform to acquire a transformed representation of the first picture, the transformed representation comprising a plurality of channels;
distributing the channels to a plurality of groups in dependence on the plurality of channels, wherein the plurality of groups comprises a first group and one or more second groups;
inserting the first group into the data stream;
deriving, based on the first picture, for each of a plurality of second pictures of the sequence of pictures, which follow the first picture in the sequence of pictures, a motion description; and
encoding the motion descriptions of the second pictures and the second groups into the data stream by interleaving the motion descriptions of the second pictures with the one or more second groups.

21. A method for decoding a sequence of pictures from a data stream, the method comprising:
decoding, from the data stream, a first group of channels of a transformed representation of a first picture of the sequence of pictures, wherein the transformed representation comprises a plurality of channels, the plurality of channels being distributed to a plurality of groups comprising the first group and a second group,
acquiring a reconstructed representation of the first picture by subjecting the first group of channels to a transform, the transform being non-linear,
decoding, from the data stream, a motion description of a second picture, which follows the first picture in the sequence of pictures, and
reconstructing the second picture based on the reconstructed representation of the first picture and the motion description of the second picture,
wherein each of the plurality of channels of the transformed representation is associated with one of a plurality of input channels of the non-linear transform, and
wherein the method comprises deriving, from the data stream, an indication of the input channels with which the channels of the first group are associated.

22. A non-transitory digital storage medium having stored there on a data stream, the data stream signaling a sequence of pictures, wherein the sequence of pictures is encoded into the data stream using the method for decoding a sequence of pictures from a data stream, the method comprising:
decoding, from the data stream, a first group of channels of a transformed representation of a first picture of the sequence of pictures, wherein the transformed representation comprises a plurality of channels, the plurality of channels being distributed to a plurality of groups comprising the first group and a second group,
acquiring a reconstructed representation of the first picture by subjecting the first group of channels to a transform, the transform being non-linear,
subjecting the reconstructed representation to a restoration model to acquire a restored representation of the first picture,
decoding, from the data stream, a motion description of a second picture, which follows the first picture in the sequence of pictures, and
reconstructing the second picture based on the restored representation of the first picture and the motion description of the second picture.

23. A non-transitory digital storage medium having a computer program stored
thereon to perform the method for decoding a sequence of pictures from a data stream, the method comprising:
decoding, from the data stream, a first group of channels of a transformed representation of a first picture of the sequence of pictures, wherein the transformed representation comprises a plurality of channels, the plurality of channels being distributed to a plurality of groups comprising the first group and a second group,
acquiring a reconstructed representation of the first picture by subjecting the first group of channels to a transform, the transform being non-linear,
subjecting the reconstructed representation to a restoration model to acquire a restored representation of the first picture,
decoding, from the data stream, a motion description of a second picture, which follows the first picture in the sequence of pictures, and
reconstructing the second picture based on the restored representation of the first picture and the motion description of the second picture, when said computer program is run by a computer.

24. A non-transitory digital storage medium having a computer program stored
thereon to perform the method for encoding a sequence of pictures into a data stream, the method comprising:
transforming a first picture of the sequence of pictures using a non-linear transform to acquire a transformed representation of the first picture, the transformed representation comprising a plurality of channels;
distributing the channels to a plurality of groups in dependence on the plurality of channels, wherein the plurality of groups comprises a first group and one or more second groups;
inserting the first group into the data stream;
deriving, based on the first picture, for each of a plurality of second pictures of the sequence of pictures, which follow the first picture in the sequence of pictures, a motion description; and
encoding the motion descriptions of the second pictures and the second groups into the data stream by interleaving the motion descriptions of the second pictures with the one or more second groups,
when said computer program is run by a computer.

25. A non-transitory digital storage medium having a computer program stored
thereon to perform the method for decoding a sequence of pictures from a data stream, the method comprising:
decoding, from the data stream, a first group of channels of a transformed representation of a first picture of the sequence of pictures, wherein the transformed representation comprises a plurality of channels, the plurality of channels being distributed to a plurality of groups comprising the first group and a second group,
acquiring a reconstructed representation of the first picture by subjecting the first group of channels to a transform, the transform being non-linear,
decoding, from the data stream, a motion description of a second picture, which follows the first picture in the sequence of pictures, and
reconstructing the second picture based on the reconstructed representation of the first picture and the motion description of the second picture,
wherein each of the plurality of channels of the transformed representation is associated with one of a plurality of input channels of the non-linear transform, and
wherein the method comprises deriving, from the data stream, an indication of the input channels with which the channels of the first group are associated, when said computer program is run by a computer.
